(19) United States
(12) Patent Application Publication
(10) Pub. No.: US 2025/0226764 A1
(43) Pub. Date: Jul. 10, 2025

(54) SYSTEMS AND METHODS TO REDUCE THE DC LINK CAPACITANCE AND IMPROVE THE RELIABILITY OF CONVERTERS

(71) Applicants: Texas A&M University System, College Station, TX (US); Board of Regents, The University of Texas System, Austin, TX (US)

(72) Inventors: Prasad Enjeti, College Station, TX (US); Hamid Toliyat, College Station, TX (US); Matthew Gardner, Austin, TX (US)

(21) Appl. No.: 19/011,283

(22) Filed: Jan. 6, 2025

Related U.S. Application Data
(60) Provisional application No. 63/618,197, filed on Jan. 5, 2024.

(51) Int. Cl. H02M 7/487; H02M 7/5387

(52) U.S. Cl. CPC H02M 7/487; H02M 7/53871

(57) ABSTRACT

The disclosure provides a system and method that rejects, or at least reduces, the effect of low frequency voltage that is fed forward to the output of an NPC converter, such as an ANPC converter. For example, a controller is disclosed that is configured to modify PWM signals to adapt to different magnitudes and frequencies of an input DC voltage ripple in real time. Additionally, the disclosure provides improved reliability of converters by including one or more redundant phases and a modified phase module. In one example, an NPC converter is disclosed that includes: (1) three different phase modules, (2) at least one redundant phase module, and (3) switching circuitry configured to enable one of the at least one redundant phase modules in response to failure of one of the three different phase modules.

### CROSS-REFERENCE TO RELATED APPLICATIONS

This application claims the benefit of U.S. Provisional Application Ser. No. 63/618,197 filed by Prasad Enjeti et al. on Jan. 5, 2024, entitled “METHODS TO REDUCE THE DC LINK CAPACITANCE AND IMPROVE THE RELIABILITY OF CONVERTERS”, which is commonly assigned with this application and incorporated herein by reference in its entirety.

### GOVERNMENT LICENSE RIGHTS

This invention was made with government support under DE-AR0001356 awarded by the Advanced Research Projects Agency-Energy (ARPA-E). The government has certain rights in this invention.

### TECHNICAL FIELD

This application is directed, in general, to converters and, more specifically, to high density DC to AC or AC to DC switching converters.

### BACKGROUND

Neutral Point Clamped (NPC) converters are a type of converters used in multilevel DC to AC or AC to DC converter systems, which are commonly used in high-power applications. For example, NPC converters can be used in 1000 volt DC systems and in applications ranging up to several megawatts. The NPC converters use a combination of a neutral point clamping circuit and capacitors to produce a smoother output voltage waveform compared to traditional converters. An NPC converter typically uses diodes to clamp the voltage at the neutral point. An active NPC (ANPC) converter is an NPC converter that uses switches with the diodes for the clamping circuit.

### SUMMARY

In one aspect, the disclosure provides a three-phase NPC converter. In one example, the NPC converter includes: (1) three different phase modules, (2) at least one redundant phase module, and (3) switching circuitry configured to enable one of the at least one redundant phase modules in response to failure of one of the three different phase modules.

In another aspect, the disclosure provides an electrical system. In one example the electrical system includes: (1) a rectifier that produces a DC voltage from an AC voltage and (2) a three-phase ANPC DC/AC converter configured to convert the DC voltage to a three-phase AC output voltage, wherein the ANPC DC/AC converter has three different phase modules and a controller configured to, using PWM signals, control switches of the three different phase modules to convert the DC voltage, wherein the PWM signals compensate for ripple in the DC voltage.

In still another aspect, the disclosure provides a method of operating a three-phase ANPC converter including; (1) receiving an input DC signal and (2) reducing an effect of low frequency voltage ripple on the input DC signal with simultaneous neutral point voltage balancing and cancellation of zero sequence voltages at an output of the converter.

### BRIEF DESCRIPTION

Reference is now made to the following descriptions taken in conjunction with the accompanying drawings, in which:

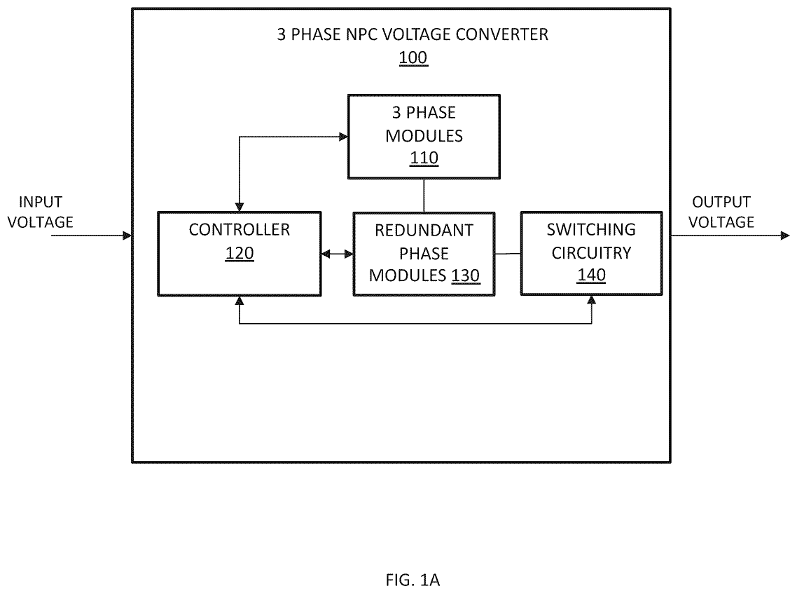

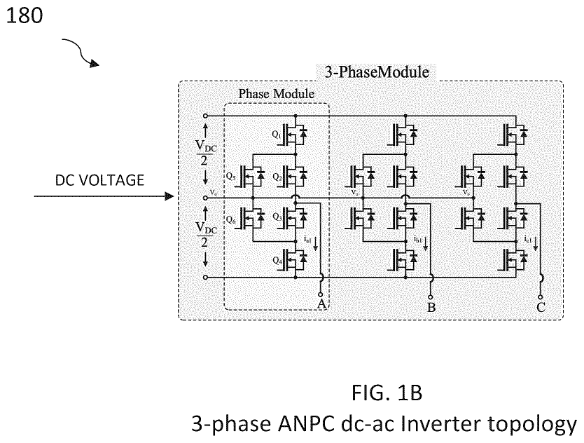

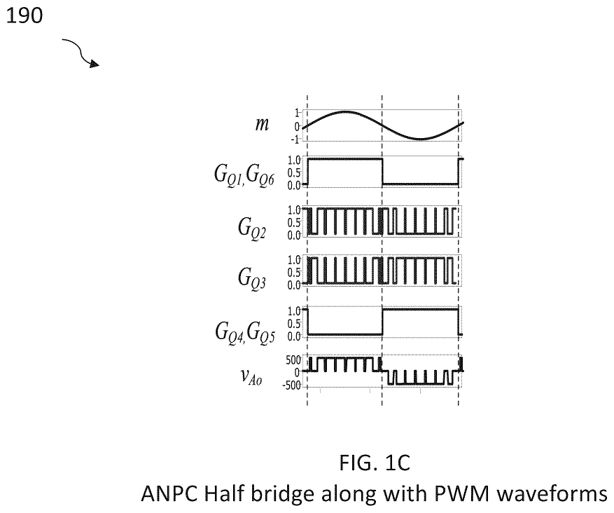

FIG. 1A illustrates a block diagram of an example of a three phase NPC converter constructed according to the principles of the disclosure;

FIG. 1B illustrates a schematic diagram of an example of a three phase ANPC DC/AC inverter constructed according to the principles of the disclosure;

FIG. 1C illustrates an example of a modulation strategy that can be used to construct the output voltage for a single phase of an ANPC inverter according to the principles of the disclosure;

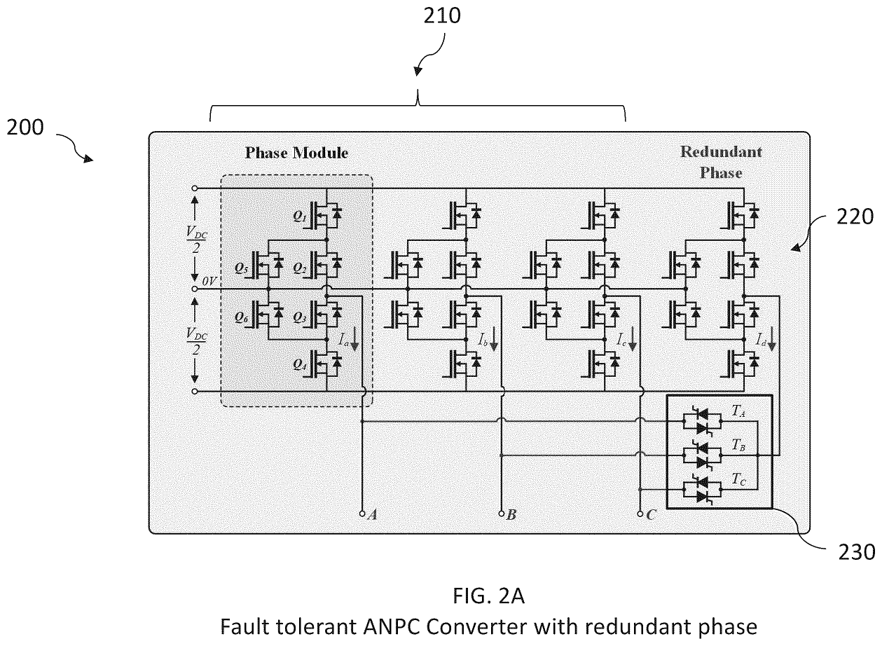

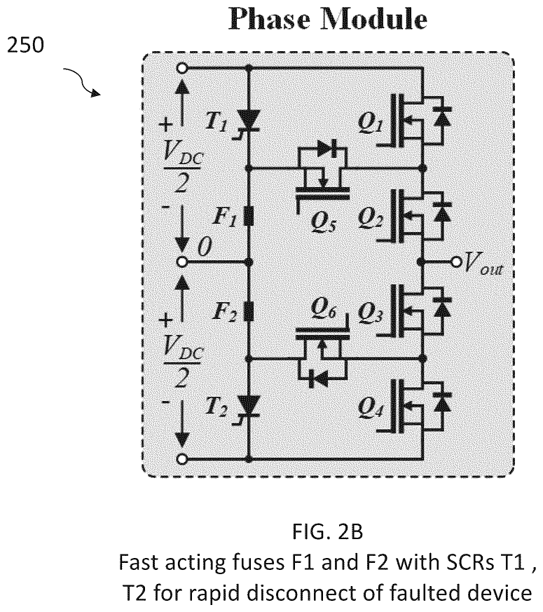

FIG. 2A illustrates a schematic diagram of an example of a fault tolerant three phase ANPC inverter constructed according to the principles of the disclosure;

FIG. 2B illustrates a schematic diagram of an example of a modified phase module constructed according to the principles of the disclosure;

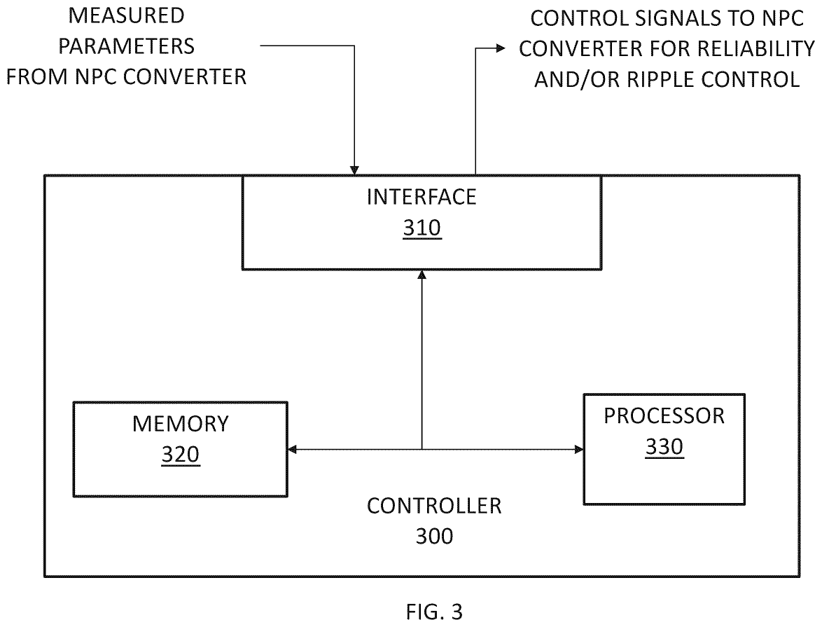

FIG. 3 illustrates a block diagram of an example of a controller of a NPC converter that is configured to electronically control ripple and activate a redundant phase module as disclosed herein;

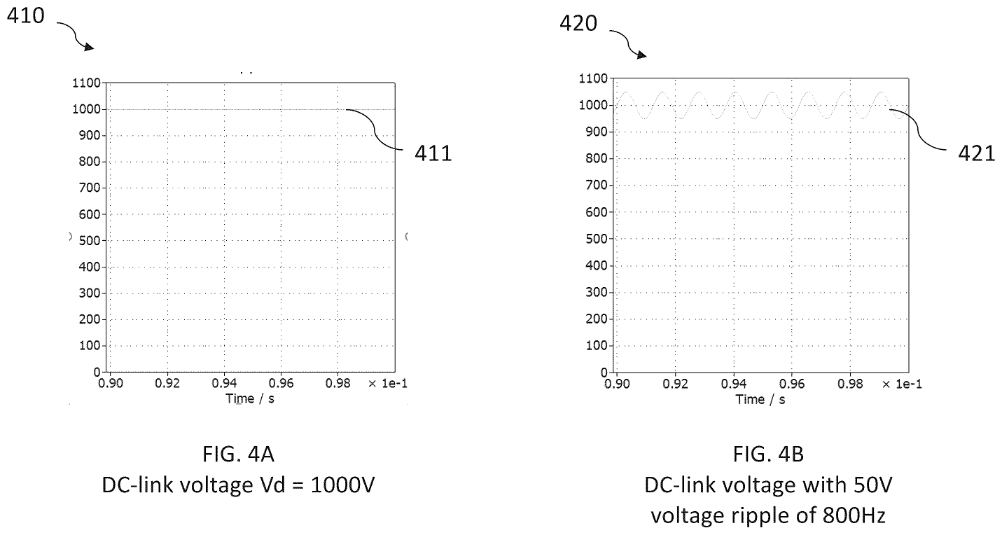

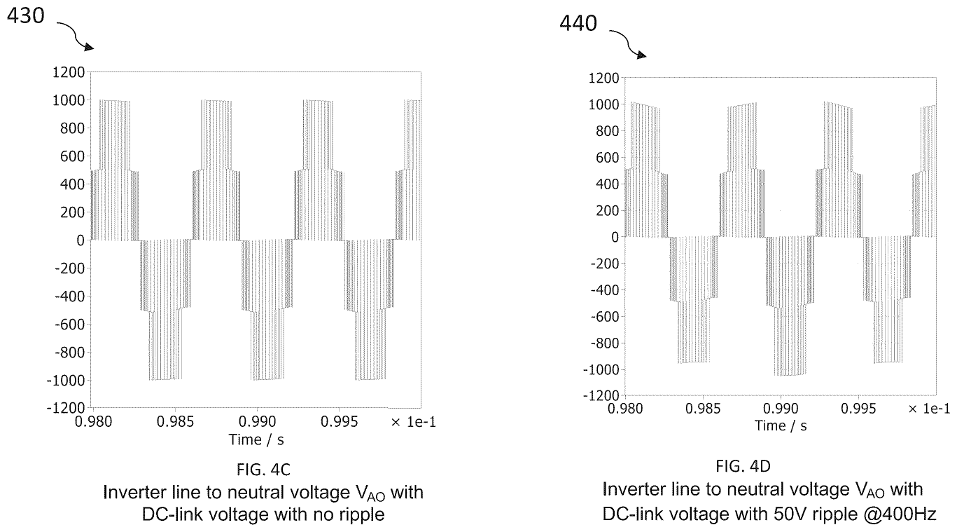

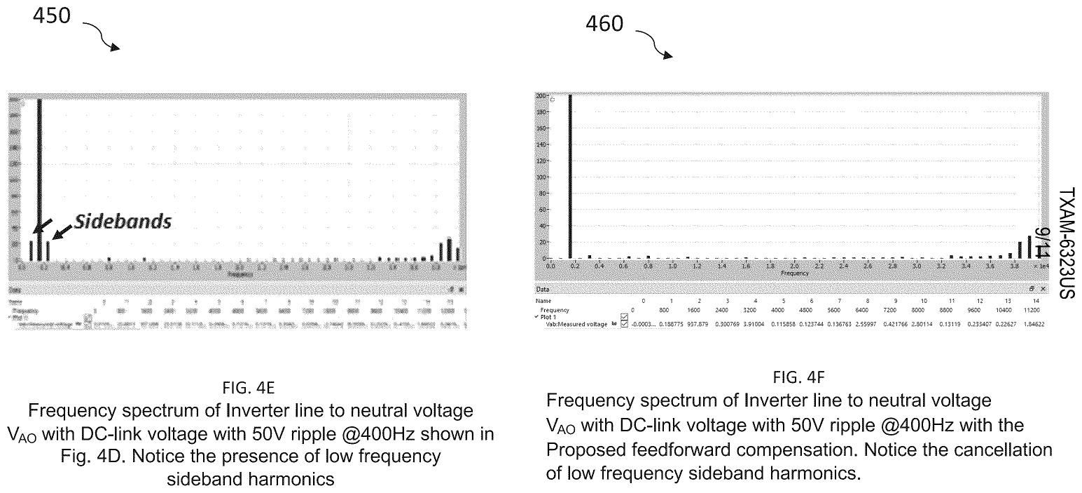

FIGS. 4A to 4D illustrate various examples of a DC voltage without ripple and with ripple;

FIGS. 4E and 4F illustrate the inverter line to neutral voltage with presence of low frequency sidebands and without sidebands;

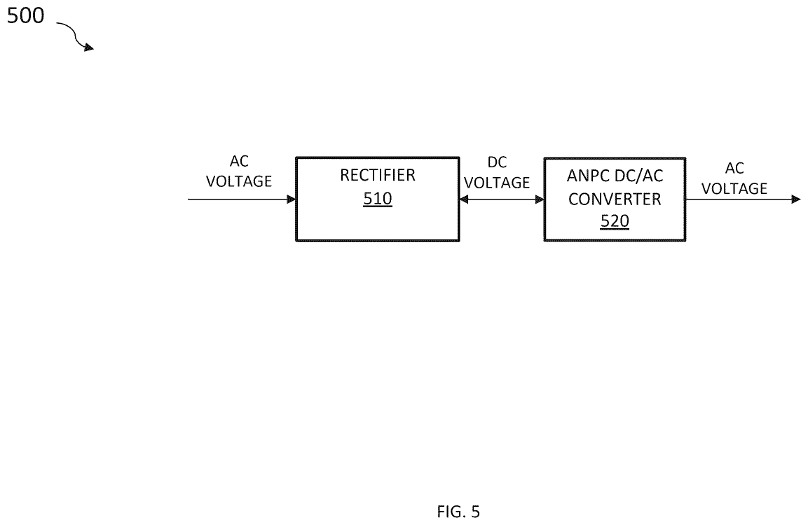

FIG. 5 illustrates a block diagram of an example of an electrical system having an ANPC DC/AC converter constructed according to the principles of the disclosure; and

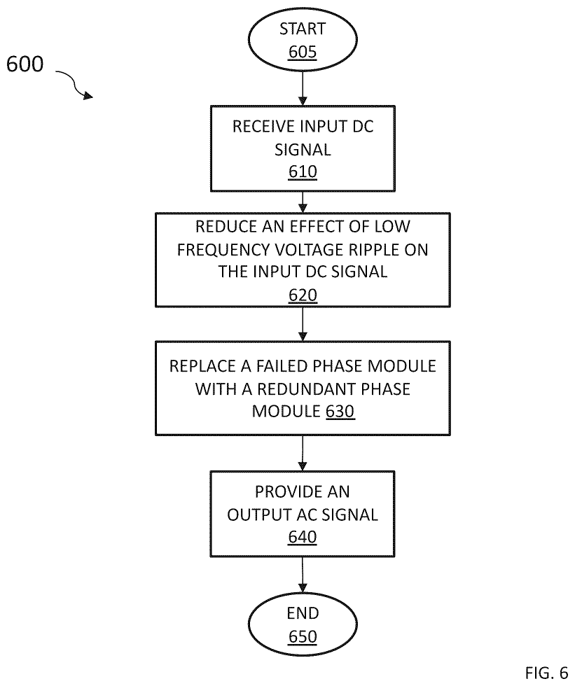

FIG. 6 illustrates a flow diagram of an example method of operating a three phase ANPC converter carried out according to the principles of the disclosure.

### DETAILED DESCRIPTION

In DC to AC voltage converters, NPC converters can be used to receive and convert a DC link voltage to an alternating voltage with variable frequency. The DC link, or simply DC voltage, received by an NPC converter can have ripple voltage (or simply ripple) due to rectification. For example, the engine of an aircraft can generate AC power for the aircraft electrical system, which can be a three phase system at 400 frequency having a line voltage of 200 volts and phase voltage of 115 volts. The speed of the engines can change during flight and this can affect the rotational speed of the generator providing the AC power. To compensate for the changes, aircraft electrical system's often use a variable speed, constant frequency system (VSC), which produces DC power for the aircraft electrical system via rectification. Due to the rectification, the DC signal can include ripple. An NPC converter can reduce the effects of the ripple using inductor/capacitor filters (L-C). The L-C filter components needed to filter the ripple, however, typically carry rated currents and contribute to additional weight/volume and also results in additional losses.

The disclosure provides a system and method that rejects, or at least reduces, the effect of low frequency voltage that is fed forward to the output of an NPC converter, such as an ANPC converter. Advantageously, the disclosed system and method electronically controls and adjusts the amount of ripple by controlling the on and off times of switches of an NPC converter using pulse width modulation (PWM). Three-phase NPC converters are disclosed that can respond in real time to reduce or eliminate the effect of the ripple to the output of the three-phase NPC converters. As such the disclosed NPC converter can respond to an input signal that is an imperfect DC voltage signal without relying on large capacitors and/or L-C filter components that are typically used. By electronically adjusting the operation of the switches, the amount of required capacitance can be reduced, which results in a reduction (or at least not an increase) of the size of the heavy and large capacitors or filter components. The electronic operation of the switches allows an overall converting system that is lighter and smaller compared to similarly rated DC to AC (DC/AC) converters. FIG. 1A provides an example of an improved NPC voltage converter with electronic ripple control. In addition to providing a lighter and smaller electrical system, the disclosure also improves the reliability of three-phase NPC converters, such as three-phase ANPC converters, compared to the existing state of the art by having one or more redundant phase modules in addition to the three different phase modules. Additionally, the disclosure provides a modified phase module that can provide further reliability for an ANPC.

FIG. 1A illustrates a block diagram of an example of a three-phase NPC converter 100 constructed according to the principles of the disclosure. The NPC converter 100 includes three phase modules 110 and a controller 120 and converts an input voltage to an output voltage by controlling switches of the three phase modules 110 via the controller 120. The controller 120 controls the operation of the switches using PWM to reduce ripple in the output voltage. For example, the NPC converter 100 can be a DC to AC converter that converts an input DC voltage into an output three-phase AC voltage. The DC to AC (or simply DC/AC) converter can be part of an electrical system of an aircraft and the DC voltage can be from a VSC of the aircraft electrical system. In addition to an output of three voltage phases, the DC/AC converter 100 also provides a voltage level output at the neutral point.

Continuing with the example of a DC/AC converter, the three phase modules 110 are different phase modules that each receive the DC voltage and provide a single output phase of the three-phase output. Each of the three different phase modules 110 can be an ANPC half bridge, such as used in a three-phase ANPC DC/AC inverter 180 as illustrated in FIG. 1B. As such, each phase of the three-phase modules includes six switches that are controlled by the controller 120 for converting the DC voltage to the three-phase AC voltage and compensating for ripple associated with the DC voltage. In some examples, the three different phase modules 110 can be an NPC half bridge and the controller 120 can control the four switches of each phase module.

The controller 120 is configured to direct operation of the NPC converter 100 by sending control signals to control operation of the switches of the three phase modules 110 for the converting and ripple compensating of the DC voltage. FIG. 1C illustrates a graph 190 showing an example of a modulation strategy that can be used to construct the output voltage for a single ANPC inverter phase used in the three-phase ANPC DC/AC inverter 180 of FIG. 1B. The same modulation strategy can be used to control each of the three phase modules 110 of a DC/AC converter. While controlling the switches, the controller 120 can employ a PWM technique as disclosed herein to actively suppress a low-frequency ripple in the input DC voltage of a DC/AC converter. As such, a size of the input capacitors can be substantially reduced, or at least not enlarged, compared to conventional NPC DC/AC converters, thereby realizing a compact DC/AC converter that delivers high performance features concurrently. Controller 300 of FIG. 3 provides an example of controller 120 that can control the operation of the switches for voltage conversion and ripple reduction.

As noted above, the three-phase modules 110 can be configured as the three-phase modules of the ANPC DC/AC inverter 180 of FIG. 1B, which uses an ANPC half bridge topology for each of the three different phases. The three-phase ANPC DC/AC invertor topology 180 includes input capacitors (not shown) that are each positioned to receive half of the DC voltage and can be used to reduce ripple associated with the incoming DC voltage. During DC-AC inverter operation, the received DC voltage is transformed into an alternating current output with variable frequency, that can be used, for example, to power a propulsion motor. The presence of six active switches per phase affords significant control versatility, enabling the handling of zero states, facilitating dynamic equalization of capacitor voltages, and nullifying zero-sequence voltage components in the output of the three-phase DC/AC inverter 180. With each phase module, the three-phase DC/AC inverter 180 allows for the operation of two switches at a high frequency, while the remaining four switches function at the line frequency. As noted above, FIG. 1C illustrates an example of a modulation strategy for phase A that operates two switches at high frequency, Q₂ and Q₃, and the remaining switches Q₁, Q₆, Q₄, and Q₅, at the line frequency. The three-phase ANPC DC/AC inverter 180 configuration can accommodate an elevated DC-link voltage, ranging from 800V to 1500V in this example, facilitated by the utilization of 1200V/1700V SiC MOSFETs.

An improved design with more reliability compared to the three-phase modules 110 of FIG. 1A, such as represented by the ANPC DC/AC inverter 180 of FIG. 1B, would be beneficial. In addition to electronically reducing ripple, the disclosure recognizes that several parameters of three-phase ANPC DC/AC converters, such as instantaneous voltage, current, device on/off state voltages, etc., can be measured continuously. The measured data can be received by the controller 120 and used to enable rapid detection of any over current/voltage and faulted condition. Upon detection of a faulted condition and the type of faulted condition, a converter topology modification can be initiated. For example, detection of a phase fault due to monitoring current can be used to implement a redundant phase. The parameters can be measured and monitored using conventional components and techniques known in the art.

As such, NPC converter 100 also includes at least one redundant phase module represented by redundant phase modules 130 and switching circuitry 140. Each of the redundant phase modules 130 are configured as a single one of the three phase modules 110. As such, the one or more redundant phase modules 130 can be an ANPC half bridge as shown in FIG. 1B or an NPC half bridge depending on the implementation. Multiple redundant phase modules can be used to provide additional contingency if more than one of the three different phase modules 110 fail.

Switching circuitry 140 is configured to operate and replace a failed one of the three phase modules 110 with one of the one or more redundant phase modules 130. The switching circuitry 140 has active components, such as, one or more silicon controlled rectifiers (SCRs) or one or more transistors. The switching circuitry 140 can be operated according to which one of the phase modules 110 is being replaced and, when there are more than one redundant phase module, which one of the one or more redundant phase modules 130 will be used. The switching circuitry 140 can be controlled via control signals from the controller 120 in response to the measured parameters. Thus, in addition to providing electronic ripple control, the NPC converter 100 can also provide improved reliability via the redundant phase modules 130 and the switching circuitry 140. FIG. 2A provides an example of a three-phase ANPC DC/AC inverter 200 having switching circuitry that uses SCRs and a single redundant phase. The topology of FIG. 2A can be used by the NPC converter 100 of FIG. 1A for the three phase modules 110 and the redundant phase modules 130.

FIG. 2A illustrates a schematic diagram of an example of a fault tolerant three phase ANPC inverter 200 constructed according to the principles of the disclosure. The fault tolerant ANPC DC/AC inverter 200 includes three-phase modules 210, a single redundant phase 220, and switching circuitry 230. The fault tolerant ANPC DC/AC inverter 200 improves reliability compared to existing ANPC inverters, and also the three-phase ANPC DC/AC inverter 180 of FIG. 1B, due to the additional fourth leg—the redundant phase 220. The built-in redundant phase 220 of the fault tolerant ANPC DC/AC inverter 200 can be used for any faulted phase leg of the three-phase modules 220 upon detecting of a fault and thus allow converting operation to continue. The switching circuitry 230 can be operated to replace a faulted one of the three-phase modules 210 with redundant phase 220. The switching circuitry 230 includes three pairs of SCRs with each one of the pairs uniquely positioned to replace a single one of the three phase modules 210 with the redundant phase 220. Accordingly, if one of the phases A, B, or C of the three-phase modules 210 were to fail, then the redundant phase 230 would take over. For example, if phase A were to fail, then TA would be turned on and the redundant phase 220 would take over for phase A.

As noted with respect to FIG. 1A, more than one redundant phase can be used. Instead of or in addition to at least one redundant phase, each phase module of the fault tolerant ANPC DC/AC inverter 200 can also be made more redundant. FIG. 2B shows topology modifications of a modified phase module 250 that includes the installation of fast acting fuses F₁, F₂, with SCRs T₁, T₂, for rapid disconnect of a faulted device connecting to the neutral point. For example, upon short circuit failure of Q₁; SCR T₁ is triggered to blow the fuse F₁ to isolate the fault. The zero state of the faulted converter can be fulfilled by Q₃ and Q₆. With these modifications a converter can continue to operate with one device failure. The modified phase module 250 can be implemented in one or more of the phase modules 110 of the three-phase NPC converter 100, one or more of the phase modules of the three-phase DC/AC inverter 180 of FIG. 1B, and in one or more of the phase modules of fault tolerant ANPC DC/AC inverter 200. The modified phase module 250 can also be used as a redundant phase module. FIG. 3 provides an example of a controller that can be used to control ripple and activate redundant phases.

FIG. 3 illustrates a block diagram of an example of a controller 300 that receives measured parameters from an NPC converter, such as three-phase NPC converter 100 and/or the inverter topologies illustrated in FIGS. 1B and 2A, and controls switches thereof to improve reliability. The controller 300 includes one or more interfaces represented by interface 310, one or more data storages or memories represented by memory 320, and one or more processors represented by processor 330. The interface 310 is a communications interface that is configured to send and receive data, such as receiving measured parameters and sending control signals to switches. The memory 320 is configured to store data including operating instructions that direct the operation of the processor 116. The operating instructions correspond to one or more algorithms directed to PWM control of phase module switches of an NPC converter and/or switching circuitry for enabling redundant phases.

For example, the controller 300 can receive measured parameters through interface 310 indicating a fault, such as a phase fault of an NPC, and direct operation of one or more switches of the NPC to cover for the faulted phase and allow the NPC to continue to operate. The controller 300 can send control signals to the switches via the interface 310 as directed by the processor 330 according to one or more algorithms stored on memory 320. For example, the controller 300 can send control signals to operate the switching circuitry 140 of the NPC converter 100 and/or the switching circuitry 230 of ANPC DC/AC inverter 180.

In addition to improving reliability, the controller 300 can receive measured parameters such as input DC voltage in 180. In cases where the input DC Voltage in 180 has low frequency ripple, the controller 300 can send control signals to operate one or more switches of phase modules of an NPC to reduce or eliminate the effects of ripple on the converter output. For example, the controller 300 can send control signals to operate the switches of the three-phase modules 110 of FIG. 1A and/or the switches of the phase modules of the ANPC inverters of FIGS. 1B and 2A. The processor 330 can generate the control signals directed to enabling a redundant phase module and controlling the ripple according to one or more algorithms stored on the memory 320. The algorithms can correspond to the methods/discussion disclosed herein and correspond, for example, to Equations 1 and 2 presented below for controlling ripple. The controller 300, therefore can improve reliability and electronically minimize the effect of input DC Voltage ripple by operating switches. The controller 300 can be communicatively coupled to the disclosed NPC converter 100 and/or inverters of FIGS. 1B and 2A via conventional means for sending control signals and receiving measured parameters.

The controller 300 can use PWM for rejecting low frequency input DC voltage ripple with simultaneous neutral point voltage balancing and cancellation of zero sequence voltages at the output. Considering an ANPC DC/AC converter, the six active switches per phase in the ANPC inverters of FIGS. 1B and 2A afford significant control versatility, enabling the handling of zero states, facilitating dynamic equalization of capacitor voltages, and nullifying zero-sequence voltage components in the inverter's output. Per each phase, the controller 300 can operate two switches at a high frequency, while the remaining four switches function at the line frequency. The controller 300 can operate the six switches of each phase using a feedforward PWM strategy to continuously neutralize the impacts of low frequency voltage oscillations on the input DC voltage. This approach ensures constant suppression of output harmonics, even in the presence of a 20% low frequency input DC voltage fluctuation. The disclosed PWM method enables a reduction in the requirement for DC-link capacitors, thereby augmenting the power density.

Regarding input DC voltage ripple cancellation, as detailed above, low frequency voltage ripple in the DC-link has a direct bearing on the quality of inverter output voltage, resulting in two low frequency sidebands. The low frequency voltage distortion directly affects the output load current resulting in torque ripple and additional losses. A feedforward ripple cancellation approach is proposed as follows:

$${V}_{d} = {V}_{dc} ( 1 + k * sin ( {ω}_{r} t ) ) \qquad ( 1 )$$

$${SW}_{new} = \frac{1}{1 + k * sin ( {ω}_{r} t )} * SW \qquad ( 2 )$$

In Equations 1 and 2, V_{d} is the input DC voltage, k is the magnitude, and or is the frequency of the low frequency input DC voltage ripple. The controller 300 modifies switching of the inverter in a feed forward manner to make adjustments in pulse width based on the low frequency voltage ripple per Equation 2. In other words, the inverter pulse width modulation SW is modified based on the DC-link voltage ripple as per Equation (2). The controller 300 is able to modify the pulse width and adapt to different magnitude and frequency of the input DC voltage ripple in real time. k and ωᵣ are from the measured parameters that are received by the controller 300.

FIGS. 4A to 4D illustrate various examples of a DC voltage without ripple and with ripple. FIGS. 4A and 4B illustrate graphs 410 and 420 showing the input DC voltage without ripple 411 and one with ripple 421. FIGS. 4C and 4D illustrate graphs 430 and 440 showing an inverter line to neutral voltage with the input DC voltage without ripple and one with ripple, respectively. FIGS. 4A to 4D are in the voltage spectrum and each of the x-axis and y-axis for each of the FIGS. 4A to 4D is time per second and volts, respectively. FIGS. 4E and 4F are in the frequency spectrum and illustrate the inverter line to neutral voltage with presence of low frequency sidebands, graph 450, and without sidebands, graph 460, according to the use of the disclosed PWM. More specifically, FIG. 4F shows the cancellation of the low frequency sidebands in the output voltage due to the presence of the DC-link voltage ripple as a result of the PWM control signals generated by the controller 300. Each of the x-axis and y-axis for FIGS. 4E and 4F are frequency and volts, respectively.

FIG. 5 illustrates a block diagram of an example of an electrical system 500 having an ANPC DC/AC converter 520 constructed according to the principles of the disclosure. In addition to the ANPC DC/AC converter 520, the electrical system 500 includes a DC voltage source that is a rectifier 510. The rectifier 510 can be or can be part of a VSC. For example, the electrical system 500 can be an aircraft electrical system and the AC input voltage provided to the rectifier 510 can be from an engine of the aircraft. The ANPC DC/AC converter 520 can include components of the NPC converter 100 of FIG. 1 that has the topology of the ANPC inverters of FIG. 1B or 2A. As such, the ANPC DC/AC converter 520 includes at least three phase modules and a controller. Additionally, the ANPC DC/AC converter can include at least one redundant phase module and a switching circuit. At least one of the three phase modules can be a modified phase module as illustrated in FIG. 2B.

FIG. 6 illustrates a flow diagram of an example method 600 of operating a three phase ANPC converter. The ANPC converter can have, for example, the configuration of three-phase ANPC DC/AC inverter 200 of FIG. 2A. Method 600 begins in step 605 with the intent of converting an input DC signal to a three-phase AC signal.

In step 610, the input DC signal is received. The input DC signal is received by the ANPC DC/AC converter, which can be part of an electrical system such as illustrated in FIG. 5. The input DC signal can be a rectified signal, such as one received in an aircraft electrical system.

In step 620, an effect of low frequency voltage ripple on the input DC signal is reduced by modifying switching of the ANPC converter in a feed forward manner to make adjustments in pulse width based on the low frequency voltage ripple. A controller, such as controller 300, can send the pulse width modulation signals in real-time based on measured parameters received from the ANPC converter. The controller can control the switches of the phase modules of the ANPC converter based on, for example, Equation 2. With simultaneous neutral point voltage balancing and cancellation of zero sequence voltages at an output of the ANPC converter, the effect of the low frequency voltage ripple of the input DC signal can be reduced.

In addition to addressing the ripple, method 600 can also replace a phase module of the converter that has failed with a redundant phase module by activating a switching circuit in step 630. The controller can operate the switching circuit based on measure parameters that indicate failure of the phase module. Switching circuit 230 is an example of a switching circuit that can be used. When multiple redundant phase modules are included with an ANPC configuration, the switching circuit can be configured to replace more than one failed phase module. One or more of the phase modules, and/or one or more of the redundant phase modules, can be a modified phase module, such as modified phase module 250 of FIG. 2B.

In step 640, method 600 provides a three-phase AC output. Method 600 can continue to generate the AC output as long as an input DC voltage is provided. In step 650, method 600 ends.

A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs or code may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter. Configured means, for example, designed, constructed, and/or programmed, with the necessary logic, algorithms, processing instructions, and/or features for performing a task or tasks.

Those skilled in the art to which this application relates will appreciate that other and further additions, deletions, substitutions and modifications may be made to the described embodiments.

Each of the aspects disclosed in the Summary can include elements of one or more of the below dependent claims in a combination.

What is claimed is:

1. A three phase Neutral Point Clamped (NPC) converter, comprising:
three different phase modules;
at least one redundant phase module; and
switching circuitry configured to enable one of the at least one redundant phase modules in response to failure of one of the three different phase modules.

2. The converter as recited in claim 1, further comprising a controller that is configured to replace a failed one of the three different phase modules with the one of the at least one redundant phase by operating the switching circuitry.

3. The converter as recited in claim 2, wherein the controller is further configured to electronically remove ripple in an output of the converter by controlling one or more switches of the three different phase modules.

4. The converter as recited in claim 3, wherein the controller is configured to control the one or more switches and the switching circuitry in response to measured parameters obtained from the NPC converter.

5. The converter as recited in claim 1, wherein the converter is an Active NPC (ANPC) DC to AC converter.

6. The converter as recited in claim 5, wherein one or more of the three different phase modules includes a modified phase module having a combination of fast acting fuses and switches for rapid disconnect for a faulted one of the three phase modules connected to a neutral point of the NPC converter.

7. The converter as recited in claim 6, wherein the switches are silicon controlled rectifiers.

8. The converter as recited in claim 6, wherein the converter is configured to continue to operate after disconnect of the faulted one of the three phase modules.

9. The converter as recited in claim 1, comprising a single redundant phase.

10. An electrical system, comprising:
a rectifier that produces a DC voltage from an AC voltage; and
a three-phase ANPC DC/AC converter configured to convert the DC voltage to a three-phase AC output voltage, including:
three different phase modules, and
a controller configured to, using pulse width modulation (PWM) signals, control switches of the three different phase modules to convert the DC voltage, wherein the PWM signals compensate for ripple in the DC voltage.

11. The electrical system as recited in claim 10, wherein the three-phase ANPC DC/AC converter further includes at least one redundant phase module and switching circuitry configured to enable one of the at least one redundant phase modules in response to failure of one of the three different phase modules.

12. The electrical system as recited in claim 11, wherein the controller is further configured to operate the switching circuitry by replace a failed one of the three different phase modules with the one of the at least one redundant phase.

13. The electrical system as recited in claim 12, wherein the controller is configured to control the one or more switches and the switching circuitry in response to measured parameters obtained from the ANPC DC/AC converter.

14. The electrical system as recited in claim 10, wherein one or more of the three different phase modules is a modified phase module having a combination of fast acting fuses and switches for rapid disconnect for a faulted one of the three phase modules connected to a neutral point of the NPC converter.

15. The electrical system as recited in claim 10, wherein the ANPC DC/AC converter includes a single modified phase module.

16. The electrical system as recited in claim 10, wherein the electrical system is an electrical system of an aircraft and DC voltage is provided by an engine of the aircraft via a variable speed, constant frequency system.

17. A method of operating a three phase Active Neutral Point Clamped (ANPC) converter, comprising:
receiving an input DC signal; and
reducing an effect of low frequency voltage ripple on the input DC signal with simultaneous neutral point voltage balancing and cancellation of zero sequence voltages at an output of the converter.

18. The method as recited in claim 17, wherein the rejecting includes operating one or more of six active switches per phase module of the converter via pulse width modulation signals that are modified according to the ripple.

19. The method as recited in claim 17, further comprising replacing a phase module of the converter that has failed with a redundant phase module by activating a switching circuit.

20. The method as recited in claim 17, wherein the ANPC converter includes three phase modules and at least one of the three phase modules is a modified phase module having a combination of fast acting fuses and switches for rapid disconnect to a neutral point of the ANPC converter.
